(19) United States
(12) Patent Application Publication
(10) Pub. No.: US 2006/0172833 A1
(43) Pub. Date: Aug. 3, 2006

(54) Drive band tensioner having a force transmitting assembly with one or more elastic biasing members

(76) Inventor: James A. Kitzmiller, New Bremen, OH (US)

Correspondence Address: Bell, Boyd & Lloyd LLC, P.O. Box 1135, Chicago, IL, 60690-1135, US

(21) Appl. No.: 11/050,164

(22) Filed: Feb. 2, 2005

(51) Int. Cl. F16H 7/22; B65H 75/48

(52) U.S. Cl. 474/101; 474/109

(57) ABSTRACT

A drive band tensioner for a band including a force transmitter. The force transmitter has at least one wall, at least one biasing member having an elastic characteristic and a retainer. The retainer supports the biasing member in a position adjacent to the wall of the force transmitter. The drive band tensioner includes a rotatable engager operatively coupled to the force transmitter. The rotatable engager is operable to engage the band so as to provide an adequate level of tension in the band.

### CROSS REFERENCE TO RELATED APPLICATIONS

This application is related to the following commonly owned co-pending patent applications: “Suspension Assembly Having Multiple Torsion Members Which Cooperatively Provide Suspension to a Wheel,” filed on Sep. 4, 2003 having U.S. patent application Ser. No. 10/655,262 and Attorney Docket No. 0114682-003; and “Vehicle Having Suspension Assembly With Multiple Torsion Members Which Cooperatively Provides Suspension,” filed on Jan. 27, 2005 having U.S. patent application Ser. No. ______ and Attorney Docket No. 0114682-005.

### BACKGROUND OF THE INVENTION

Many vehicles and other machines have drive bands, such as drive belts and chains. The drive bands are used to transfer motion from one mechanism to another mechanism. The drive bands are typically coupled to several rotating pulleys which, in turn, are connected to the internal parts of the machines. Drive bands are available in different sizes so they can fit the various types of pulley arrangements. The proper level of tension can vary from application to application, but, in general, the drive bands should have a sufficient level of tension to avoid slipping. At the same time, if the level of tension is too high, the high tension can cause improper operation of the machine, damage to the pulleys or undue stress and deterioration of the drive bands.

After the drive band is installed, the level of tension in the drive band can change for several reasons. Rubber drive bands tend to gradually stretch over their lifetimes. In addition, because they are made of rubber, these bands can contract or expand with changes in temperature. The pulleys can also move out of place as a result of worn bearings or loosening of their fasteners. This movement of the pulleys can result in a decrease in tension of various types of drive bands.

Certain approaches have been taken to maintain an adequate level of band tension. One approach involves periodically disassembling the drive assembly and adjusting the position of the pulleys to increase or decrease the tension of the drive band. This approach has several disadvantages. One disadvantage is the relatively high degree of downtime, service labor and inconvenience. Operating conditions can also cause adjustable pulleys to move on their own which, in turn, can create slack in the drive band. This can result in unexpected breakdowns.

Another disadvantage relates to the vibration of the drive band. From time to time, the drive band can be subject to vibrational forces caused by various operating conditions. These forces can, in and of themselves, be great enough to increase the tension of the drive band. Because the pulleys are installed to be fixed in one place, the vibrational forces can cause a relatively high level of band stress and tension, which, in turn, can result in decreased life of the band or even failure of the band.

Another approach taken to maintain band tension involves connecting metallic wire springs (such as helical wire springs or helical torsion wire springs) to one of the pulleys. The wire springs push the pulley against the drive band to produce tension in the drive band. These wire springs can fail or break as a result of spring surges or fatigue loading caused by the vibrational forces described above. These helical wire springs may not produce a force sufficient to provide a level of tension that is adequate for many drive bands. Wire springs can also lose their spring force in relatively short periods of operating time. As a result, the wire springs must be monitored, lubricated and replaced on a relatively frequent basis.

Therefore, there is a need to overcome each of the disadvantages described above.

### SUMMARY OF THE INVENTION

The drive band tension controller or drive band tensioner of the present invention produces tension in a band of a drive assembly. The drive band tensioner can be used in conjunction with, or as part of, a drive assembly of a vehicle or other machine, such as a bailer pulled behind a tractor. In one embodiment, the drive band tensioner includes a square-shaped steel inner rod surrounded by a plurality of elastic outer rods, preferably made of a suitable rubber material. The drive band tensioner also includes a square-shaped tube which encases the elastic outer rods and the inner rod. The tube substantially confines each of elastic outer rods to a wedge-shaped slot where the inner walls of the tube intersect. One end of the tube is connected to the drive assembly support. Here, the ends of the elastic outer rods and the end of the inner rod are preferably free. That is, these ends are preferably not secured to the tube or to the drive assembly support. The opposite end of the inner rod is connected to an arm which, in turn, is connected to a free rotating pulley, sprocket or idler.

The drive band tensioner can be installed during the manufacturing stage of a vehicle or machine or in the after-market stage. In either case, the desired orientation of the arm relative to the band of the drive assembly can be determined by assessing the level of tension in the band caused by the selected position of the pulley. Once this orientation is determined, the tube can be mounted to the support structure or support member of the drive assembly. The elastic outer rods, which function as spring devices, produce a biasing force which is transmitted to the arm which, in turn, is transmitted to the pulley and which, in turn, is transmitted to the band. The spring-activated idler provides a self-adjusting, adequate level of tension to bands of drive assemblies while reducing downtime and maintenance services.

It is therefore an advantage of the present invention to provide a drive band tension controller or drive band tensioner having a force transmitting assembly with one or more elastic biasing members.

Another advantage of present invention is to increase the reliability of band tensioning mechanisms.

Still another advantage of the present invention is to decrease the level of maintenance associated with band tensioning mechanisms.

Another advantage of the present invention is to decrease the need to replace parts for band tensioning mechanisms.

Another advantage of the present invention is to reduce the quantity of moving parts in band tensioning mechanisms.

Still another advantage of the present invention is to decrease the downtime in vehicles and machines caused by inadequate band tension in drive assemblies.

Yet another advantage of the present invention is to reduce or eliminate the need to lubricate band tensioning mechanisms.

Another advantage of the present invention is to provide a relatively compact configuration for band tensioning mechanisms.

Still another advantage of the present invention is to increase the convenience and ease of installing bands on drive assemblies.

Yet another advantage of the present invention is to decrease the cost of manufacturing band tensioning mechanisms.

Another advantage of the present invention is to increase the lifetime of band tensioning mechanisms.

Additional features and advantages of the present invention are described in, and will be apparent from, the following Detailed Description of the Invention and the figures.

### BRIEF DESCRIPTION OF THE FIGURES

FIG. 1 is a side perspective view of a vehicle pulling a machine having the drive band tensioner in one embodiment of the present invention.

FIG. 2 is a side elevation view of a drive assembly in one embodiment of the present invention.

FIG. 3 is a right side perspective view of the drive band tensioner engaged with a band in one embodiment of the present invention.

FIG. 4 is a right side perspective view of the force transmitting assembly of the drive band tensioner in one embodiment of the present invention.

FIG. 5 is a rear perspective view of the force transmitting assembly of the drive band tensioner in one embodiment of the present invention.

FIG. 6 is a right side elevated view of the drive band tensioner in one embodiment of the present invention.

FIG. 7 is a front elevated view of the drive band tensioner illustrating the free or disengaged position of the band engager in one example of one embodiment of the present invention.

FIG. 8 is a front elevated view of the drive band tensioner illustrating a manually-held position of the band engager in one example of one embodiment of the present invention.

FIG. 9 is a front elevated view of the drive band tensioner illustrating a band engaged position of the band engager in one example of one embodiment of the present invention.

### DETAILED DESCRIPTION OF THE INVENTION

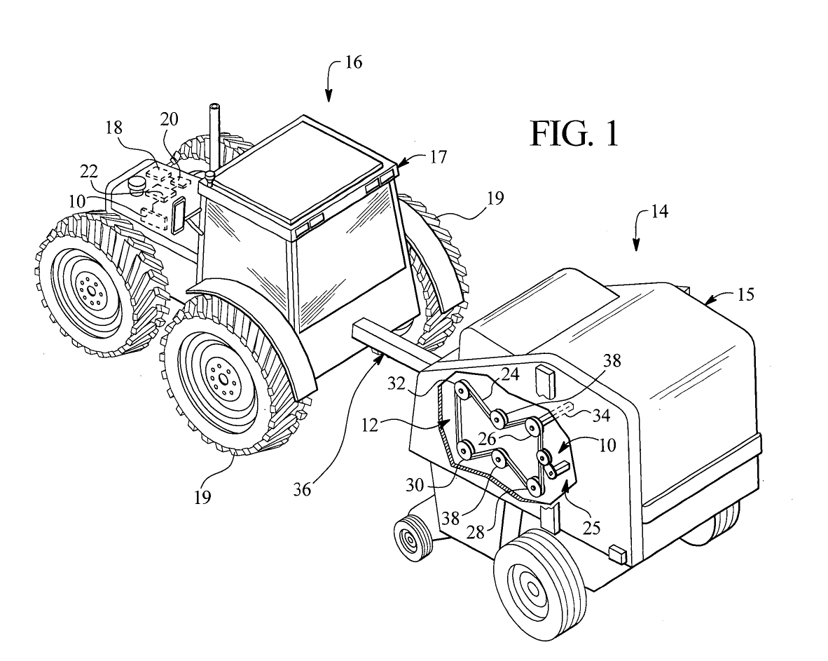

Referring now to FIG. 1, the band tension controller or drive band tensioner 10 of the present invention can be used in conjunction with, or as part of, any suitable drive assembly 12 of any machine 14, such as the bailer 15. In addition, the drive band tensioner 10 can be used in conjunction with, or as part of, a vehicle 16, such as the tractor 17.

In the illustrated example, the tractor 17 includes: (a) a power source 18, such as an engine; (b) a transmission system (not shown) that couples the power source 18 to the drive wheels 19 for moving the tractor; and (c) a drive assembly 22, similar to drive assembly 12 described below, having a drive shaft 20 that is coupled to the power source 18 of the tractor 17.

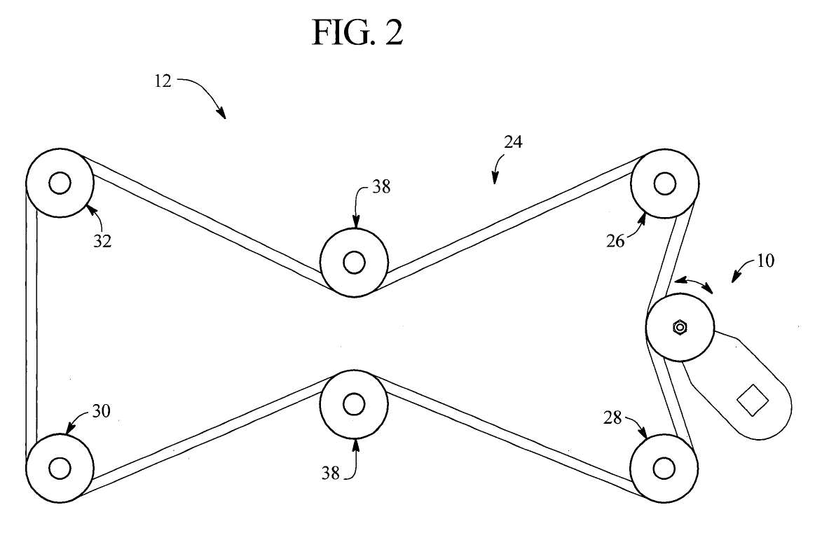

As illustrated in FIGS. 1 and 2, in one example of one embodiment, the drive assembly 12 of the bailer 15 includes: (a) a flexible serpentine motion transmitter or drive band 24; (b) a plurality of rotatable motion transmitters 26, 28, 30 and 32; (c) at least one drive shaft 34 which is operatively coupled to both the rotatable motion transmitter 26 and the transmission mechanism 36 of the tractor 17; (d) a plurality of idlers or rotatable engagers or guides 38 which engage the drive band 24 and direct or guide the drive band 24 so as to have a designated shape or path; and (e) a drive assembly support or frame 25 which supports the drive assembly 12. The serpentine motion transmitter or drive band 24 can include any flexible material or device including, without limitation, a belt, chain, cable, cord, wire or rope. It should be understood that, for purposes of this detailed description, an elongated device is considered to be flexible if the device is bendable along a portion of its length, even though discrete segments of the device may be rigid. For example, a chain is considered to be flexible even though the individual links of the chain may be rigid.

In operation of the drive assembly, the motion transmitter 26 transmits clockwise or counterclockwise motion to the drive band 24. As the drive band 24 moves, the idlers or guides 38 cause the drive band 24 to have a designated shape, such as any suitable serpentine configuration. The guides 38 can also reduce a certain level of the slack in the drive band 24. The drive band 24 transmits motion from the motion transmitter 26 to the other motion transmitters 28, 30 and 32. In turn, the motion transmitters 28, 30 and 32 transmit motion to one or more mechanisms or shafts (not shown) within the bailer 15. As the drive band 24 moves, the drive band tensioner 10 maintains a suitable level of tension in the drive band 24 as described below.

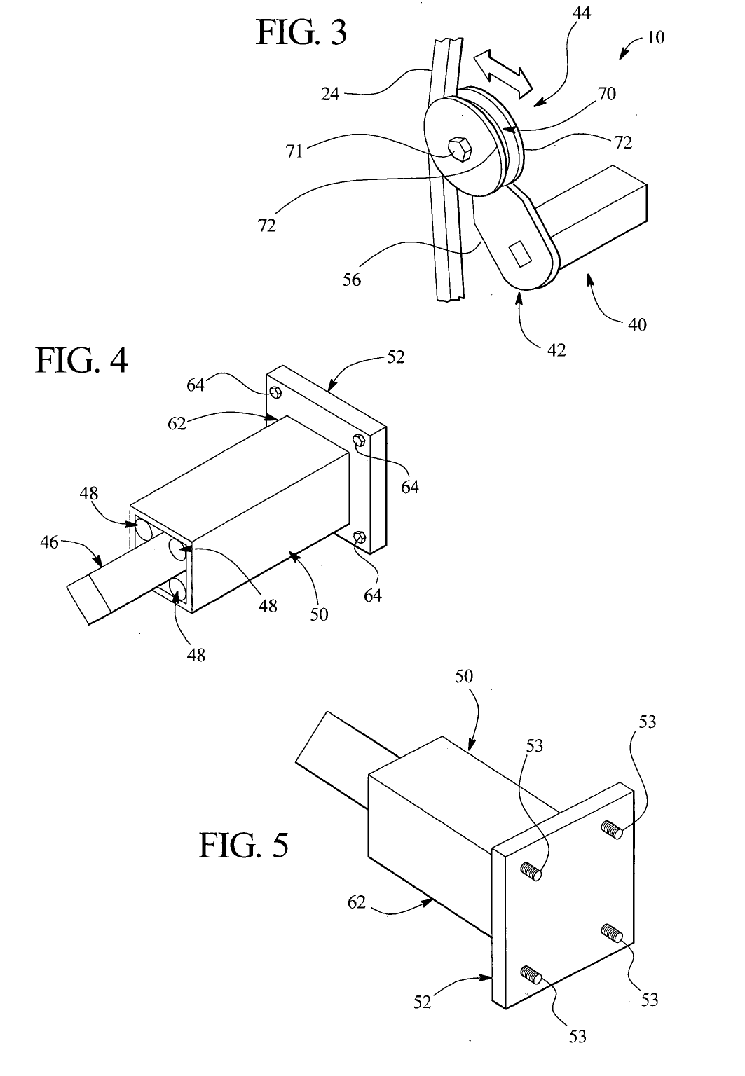

As illustrated in FIG. 3, the drive band tensioner 10 includes: (a) a force transmitting assembly 40 connecting the drive band tensioner 10 to the support or frame 25 of the machine 14; and (b) a bar or arm 42 operatively coupling the force transmitting assembly 40 to a rotatable guide or rotatable band engager 44.

Referring to FIGS. 4 through 6, the force transmitting assembly 40 of the drive band tensioner 10 includes: (a) a centrally-located, linear-shaped force transmitter 46 which transmits or transfers a spring force to the band engager 44; (b) at least one and preferably a plurality of linear-shaped biasing members 48 positioned about the perimeter of the linear force transmitter 46 so as to apply a spring force to the force transmitter 46; (c) a retainer, encasement or housing 50 which houses the linear force transmitter 46 and the linear biasing members 48 and which also maintains the linear biasing members 50 at a designated position relative to the linear force transmitter 46; and (d) a securing member 52 which mounts or connects the housing 50 to the frame 25 of the machine 14.

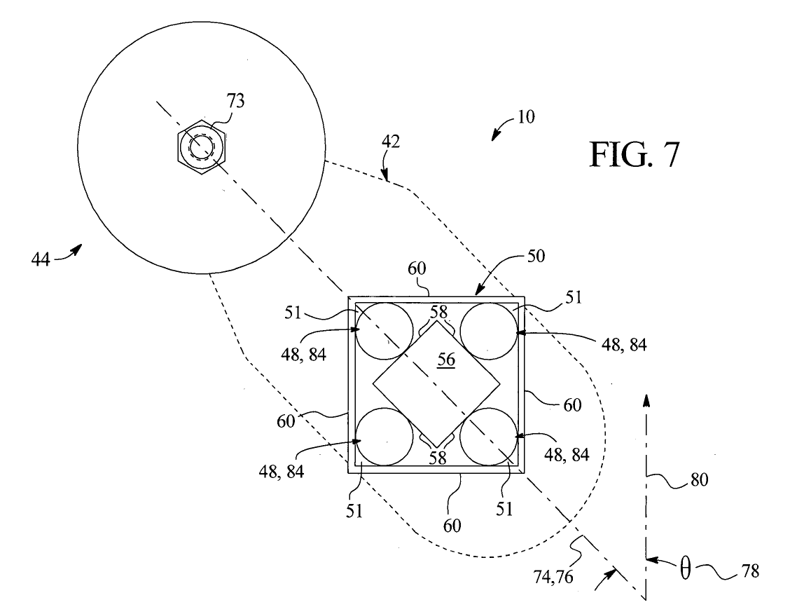

The linear force transmitter 46 is preferably a relatively rigid linear-shaped device such as a bar, shaft or rigid rod having an end 54 adjacent to the frame 25 and another end 56 connected to the arm 42. The linear force transmitter 46 is preferably constructed of a relatively hard material, including, but not limited to, steel, iron, a suitable metal, a suitable alloy composition or a suitable plastic or polymer. As best illustrated in FIGS. 7 through 9, the linear force transmitter 46 has a plurality of engagers or outer walls 58, each of which engages one of the biasing members 48. It should be appreciated that the linear force transmitter 46 can include any suitable number of walls or surfaces which engage the biasing members 48. The exterior surface of the linear force transmitter 46 can have any suitable geometric shape, including, without limitation, the square shape illustrated in FIGS. 4 through 9.

Each of the linear biasing members 48 has: (a) an elastic or resilient property or characteristic; (b) a solid body or solid core 57, preferably having no gaps, spaces or air pockets other than those formed during the formation of the biasing members 48; and (c) a plurality of ends 58. It is preferable that each of the biasing members 48 has an elastic or deformable material, including, but not limited to, natural rubber, synthetic rubber or any chemical composition providing a suitably elastic characteristic. In one embodiment, each of the deformable linear biasing members 48 includes a solid cylindrical rubber rod or an elastic rod.

It should be appreciated that the biasing members can have any suitable configuration. In one embodiment, the biasing members have: (a) a solid body or solid core; (b) an elastic or resilient property or characteristic; and (c) any suitable shape, including, but not limited to, a spherical shape, disk shape, cube shape or box shape. These solid biasing members can be relatively small or short.

As best illustrated in FIGS. 7 though 9, the housing 50 of the force transmitting assembly 40 includes a plurality of walls 60 which surround the linear biasing members 48. The walls 60 intersect to form a plurality of wedge-shaped spaces or slots 51 which extend along the length of the housing 50. Each of the linear biasing members 48 is engaged by two of the walls 60 of the housing 50. At the same time, each of the biasing members 48 is engaged by one of the walls 58 of the linear force transmitter 46. The walls 60 of the housing 50 assist in restricting the movement of the biasing members 48 so that a substantial portion of the biasing members 48 preferably remains positioned at or near one of the wedge-shaped slots 51. As described below, depending upon the orientation of the linear force transmitter 46 relative to the housing 50, the biasing members 48 will produce a force urging the arm 42 in a clockwise or counterclockwise direction.

Referring back to FIGS. 4 and 5, the securing member 52 of the force transmitting assembly 40 includes a fastener or a mount which is connected to the end 62 of the housing 50. In addition, the securing member 52 includes a plurality of fasteners 53 (such as bolts) which connect the securing member 52 to the frame 25. The end 62 of the housing 50 is preferably connected to the securing member 52 by a weld connection, although any suitable fastener or connecting method may be used. Alternatively, the securing member can be integral with the housing 50. For example, the housing 50 can include an integral flange which is fastened to the frame 25.

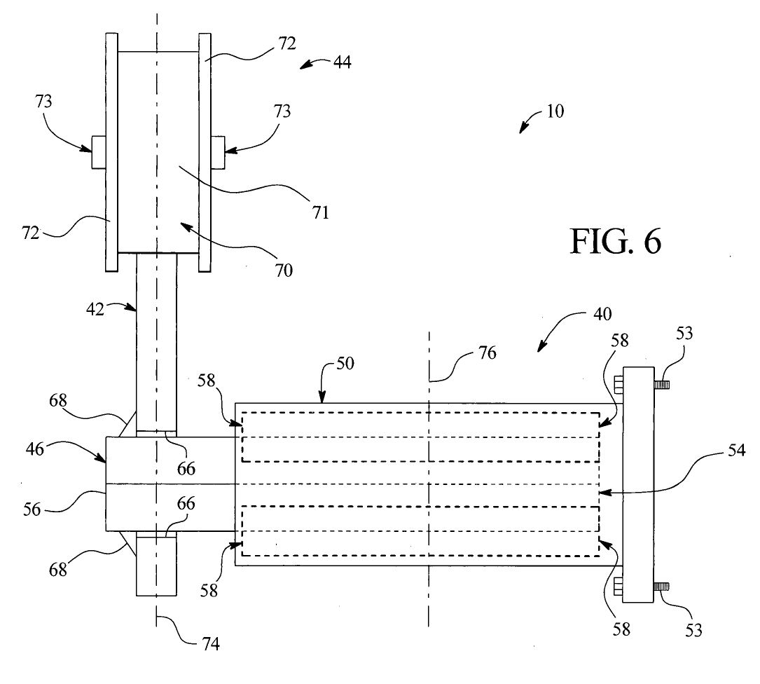

As best illustrated in FIG. 6, the arm 42 of the drive band tensioner 10 has at least one wall 66 which defines an opening that receives the end 56 of the linear force transmitter 46. In the embodiment illustrated in FIG. 6, the end 56 of the transmitter 46 is secured to the arm 42 by weld connections 68. It should be appreciated, however, that any suitable fastener, including, without limitation, a pin, or a bolt and nut combination, can be used to secure the force transmitter 46 to the arm 42. Alternatively, the arm can be constructed so as to be integral with the linear force transmitter 46.

As best illustrated in FIGS. 3 and 6, in one embodiment the idler or band engager 44 of the drive band tensioner 10 includes a free-rotating preferably disk-shaped guide, such as a wheel, pulley or roller. In one embodiment, the edge at the circumference of the band engager 44 includes: (a) a lower or recessed band engagement wall 70 which engages with the drive band 24; (b) a plurality of sidewalls or band guide walls 72 which direct the drive band 24 to remain engaged with the band engagement wall 70; (c) a channel, trough or slot 71 defined by the band guide walls 72; and (d) a bolt and nut fastener 73 which secures the band engager 44 to the arm 42.

Referring now to FIGS. 6 through 9, in one example, the arm 42 is connected to the force transmitter 46 at an orientation so that a longitudinal axis 74 of the arm 42 is parallel to the axis 76. The axis 76 passes through (and is normal to) the length or longitudinal axis of the force transmitter 46. These axes 74 and 76 form the same angle 78 relative to a Y-axis 80. Accordingly, if the drive band 24 were removed, the force transmitting assembly 40 would cause the band engager 44 to be positioned at the angle 78 relative to the Y-axis 80, as illustrated in FIG. 7.

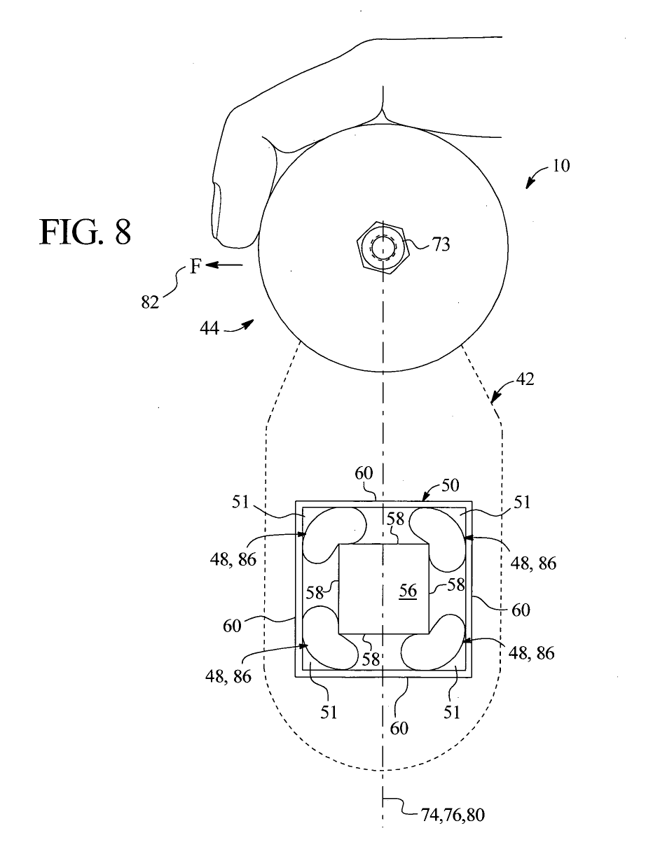

If, as illustrated in FIG. 8, one were to pull the band engager 44 in a clockwise direction until the longitudinal axis 74 of the arm 42 (and consequently the axis 76 of the transmitter 46) were each parallel to the Y-axis 80, the drive band tensioner 10 would produce a relatively high force 82 acting in the counterclockwise direction. In this example, each of the biasing members 48 would change from a circular or non-deformed shape 84 (illustrated in FIG. 7) to the partially flattened or deformed shape 86 illustrated in FIG. 8. Due to the elastic or resilient characteristic of the linear biasing members 48, the biasing members 48 would exert or produce the force 82, urging the force transmitter 46 (and consequently, the arm 42 and band engager 44) in a counterclockwise direction.

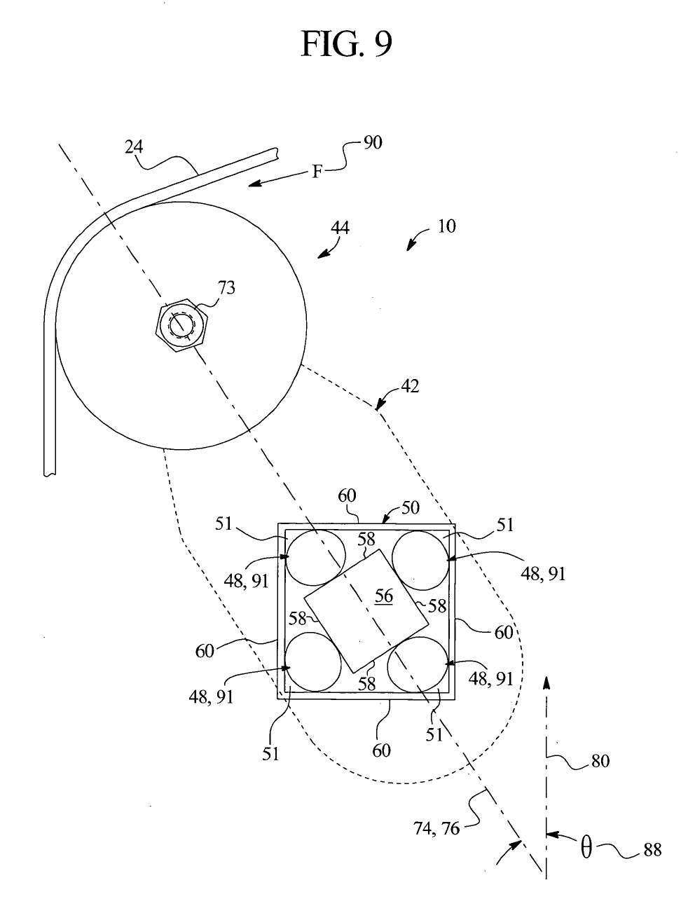

If released from this position, the band engager 44 would move in a counterclockwise direction until it reached or engaged with the drive band 24, as illustrated in FIG. 9. Here, the axes 74 and 76 would each form the same angle 88 relative to the Y-axis 80, and the linear biasing members 48 would have partially oval or deformed shapes 91. The force 90 of the drive band tensioner 10 would, at any one time, be equal to or substantially equal to the opposing force of the drive band 24 which may include vibrational forces. The sum of the forces on the drive band 24 would yield a suitable level of band tension. Because the drive band tensioner 10 provides a spring force, the drive band tensioner 10 is movable in response to vibrational forces as well as changes in the length of the drive band 24.

In the examples illustrated in the FIGS. 1 through 9, the drive band tensioner 10 is oriented so as to produce a counterclockwise force on the drive band 24. It should be understood that in other embodiments not shown, the drive band tensioner 10 can be oriented so as to produce a clockwise or upward or downward force acting on the drive band 24.

It should also be appreciated that the drive band tensioner of the present invention can be used in conjunction with or as part of any suitable machine, machinery, vehicle or mechanism including, without limitation, a land vehicle (such as an automobile or truck), water vehicle, air vehicle, recreational vehicle, utility vehicle, tractor, hitchable machine (such as a bailer, trailer or carriage), lawnmower, a fuel-powered device and an electrical-powered device.

In one embodiment, the drive band tensioner of the present invention can include a tension setter which assists an installer or user in setting the level of tension. Here, the installer or user can first mount the housing 50 to the frame 25. Then, the installer or user can use the tension setter to set the desired level of tension in the drive band 24. In one embodiment, the tension setter includes at least one insert or adapter. The adapter includes one portion that mates with or secures to the end 56 of the force transmitter 46, and the adapter has another portion that mates with or secures to the wall 66 of the arm 42. These two portions of the adapter are angularly offset from one another according to a designated orientation. Having access to a kit of such adapters or inserts can assist installers or users in setting the level of tension.

In another embodiment, the drive band tensioner of the present invention includes: (a) one or more torsion bar-springs, such as the force transmitter 46, coupled to the frame 25 of the machine 14; (b) a bar or arm 42 operatively coupled to such one or more torsion bar-springs; and (c) a rotatable guide or rotatable band engager 44 connected to the arm 42. In this embodiment, the one or more torsion bar-springs or torsion rods produce a biasing force which produces a suitable tension in the drive band 24.

The tension controller or drive band tensioner of the present invention, in one embodiment, includes a linear force transmitter, such as a rod, connected to an arm which, in turn, is connected to an idler. The drive band tensioner is mountable adjacent to the drive assembly of a vehicle or other machine. The linear force transmitter is surrounded by one or more deformable linear biasing members. The drive band tensioner also includes a retainer, such as a tube, which maintains the linear biasing members in engagement with the linear force transmitter. The retainer is attached to a frame of a machine at a designated orientation relative to the arm. In operation, the idler applies a tensioning force to the band, maintaining an adequate level of tension in the band. This type of drive band tensioner decreases the level of maintenance associated with drive bands and drive assemblies and also increases the reliability and proper function of drive assemblies.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A drive band tensioner operable to produce tension in a drive band, the drive band tensioner comprising:
a retainer having at least one inner wall;
a force transmitter supported by the inner wall of the retainer, the force transmitter having at least one wall;
at least one biasing member supported by the inner wall of the retainer, the biasing member positioned adjacent to the wall of the force transmitter, the biasing member having a solid core and an elastic characteristic; and
a rotatable band engager operatively coupled to the force transmitter, the rotatable band engager operable to engage the drive band to produce a desired amount of tension in the drive band.

2. The drive band tensioner of claim 1, wherein the drive band is selected from the group consisting of a belt, a chain, a cable, a chord, a wire and a rope.

3. The drive band tensioner of claim 1, wherein the force transmitter has a linear shape.

4. The drive band tensioner of claim 3, wherein the biasing member has a linear shape and includes an elastic material.

5. The drive band tensioner of claim 4, wherein the elastic material is selected from the group consisting of a natural rubber and a synthetic rubber.

6. The drive band tensioner of claim 1, wherein the retainer has a linear shape, the retainer having at least one inner wall adjacent to the biasing member.

7. The drive band tensioner of claim 1, wherein the rotatable band engager includes a disk-shaped idler.

8. A drive band tensioner comprising:
a tube having at least one inner wall;
a rigid rod supported by the inner wall of the tube, the rigid rod having a plurality of ends;
at least one elastic rod supported by the inner wall of the tube; and
a wheel rotatably coupled to one of the ends of the rigid rod, the wheel having an outer edge, the outer edge defining a slot sized to receive a portion of a drive band.

9. The drive band tensioner of claim 8, wherein the drive band is a device selected from the group consisting of a belt, a chain, a cable, a chord, a wire and a rope.

10. The drive band tensioner of claim 8, wherein the elastic rod is selected from the group consisting of a natural rubber and a synthetic rubber.

11. The drive band tensioner of claim 8, which includes a plurality of elastic rods housed by the tube.

12. The drive band tensioner of claim 11, wherein the rigid rod includes a plurality of walls, each of the walls positioned so as to engage a different one of the elastic rods.

13. An idler operable to engage a drive band of a drive assembly, the idler comprising:
a housing having a linear shape and plurality of inner walls;
a force transmitter supported by the inner wall of the housing, the force transmitter having a linear shape and plurality of outer walls;
a plurality of deformable biasing members supported by the inner walls of the housing, each of the deformable biasing members having a linear shape, a solid core and an elastic characteristic, each of the deformable biasing members engaged with a plurality of the inner walls of the housing;
an arm coupled to the force transmitter; and
a wheel rotatably coupled to the arm, the wheel having a drive band engagement wall and a plurality of sidewalls.

14. The idler of claim 13, wherein the drive band is selected from the group consisting of a belt, a chain, a cable, a chord, a wire and a rope.

15. The idler of claim 13, wherein the force transmitter includes a rod having a first end and a second end, the first end being connected to the arm and each of the outer walls being engaged with one of the deformable biasing members.

16. The idler of claim 15, wherein each of the deformable biasing members includes a rod having an elastic characteristic.

17. The idler of claim 13, wherein the housing includes a tube having a first end adjacent to the arm and a second end, the inner walls surrounding the deformable biasing members which, in turn, surround the force transmitter.

18. The idler of claim 13, which includes a securing member connected to the housing, the securing member securing the housing to a frame, the frame supporting the drive assembly.

19. The idler of claim 17, wherein the arm includes at least one wall defining an opening, the wall receiving a portion of the force transmitter.

20. The idler of claim 19, which includes at least on fastener which secures the portion of the force transmitter to the wall of the arm.

21. A drive assembly comprising:
at least one drive band;
a plurality of rotatable motion transmitters connectable to a support member, each of the rotatable motion transmitters engaged with the drive band;
at least one rotatable guide connectable to the support member, the rotatable guide engaged with the drive band;
at least one drive shaft coupled to at least one of the rotatable motion transmitters, the drive shaft operatively coupled to a power source;
a retainer having at least one inner wall, the retainer being connectable to the support member;
a force transmitter supported by the inner wall of the retainer, the force transmitter having at least one wall, the force transmitter coupled to the rotatable guide; and
at least one deformable biasing member supported by the inner wall of the retainer, the deformable biasing member having a solid core and an elastic characteristic, the deformable biasing member being engaged with the wall of the force transmitter.

22. The drive assembly of claim 21, wherein the drive band is selected from the group consisting of a belt, a chain, a cable, a chord, a wire and a rope.

23. The drive assembly of claim 21, wherein the retainer includes a tube having at least one inner wall adjacent to the deformable biasing member.

24. The drive assembly of claim 21, wherein the rotatable guide includes a disk-shaped idler.

25. The drive assembly of claim 21, which includes a transmission coupling device that couples the drive assembly to a machine having a power source.

26. The drive assembly of claim 21, wherein the support member and the power source are portions of a machine.

27. The drive assembly of claim 26, wherein the machine is selected from the group consisting of a hitchable machine, a bailer, a trailer, a carriage and a vehicle.

28. The drive assembly of claim 26, wherein the machine is selected from the group consisting of a land vehicle, a water vehicle, an air vehicle, a recreational vehicle, a utility vehicle, a tractor, lawn mower, a fuel-powered device and an electrical-powered device.

29. A tensioner operable with a drive assembly, the tensioner comprising:
a retainer having at least one inner wall;
a force transmitter supported by the inner wall of the retainer, the force transmitter having at least one wall;
at least one biasing member supported by the inner wall of the retainer, the biasing member positioned adjacent to the wall of the force transmitter, the biasing member having a solid core and an elastic characteristic; and
a rotatable engager operatively coupled to the force transmitter, the rotatable engager having an outer surface sized to engage at least part of a serpentine motion transmitter.

30. The tensioner of claim 29, wherein the serpentine motion transmitter is selected from the group consisting of a belt, a chain, a cable, a chord, a wire and a rope.

31. The tensioner of claim 29, wherein the force transmitter has a linear shape.

32. The tensioner of claim 31, wherein the biasing member has a linear shape and includes an elastic material.

33. The tensioner of claim 32, wherein the elastic material has a material selected from the group consisting of a natural rubber and a synthetic rubber.

34. The tensioner of claim 31, wherein the retainer has a linear shape, the retainer having at least one inner wall adjacent to the biasing member.

35. The tensioner of claim 29, wherein the rotatable engager includes a disk-shaped idler.
